(19) United States
(12) Patent Application Publication
(10) Pub. No.: US 2012/0314140 A1
(43) Pub. Date: Dec. 13, 2012

(54) Remote Control Unit for a Personalized Video Programming System

(76) Inventors: Philip R. WISER, Nevada City, CA (US); Yagyensh C. PATI, Woodside, CA (US); Michael YOUSSEFMIR, Portola Valley, CA (US)

(21) Appl. No.: 13/444,764

(22) Filed: Apr. 11, 2012

Related U.S. Application Data
(63) Continuation of application No. 12/290,583, filed on Oct. 31, 2008, now abandoned.
(60) Provisional application No. 60/985,173, filed on Nov. 2, 2007.

(51) Int. Cl. H04N 5/44; H04N 21/236; H04N 21/24

(52) U.S. Cl. 348/734; 725/13; 725/34; 348/E05.096

(57) ABSTRACT

Systems and methods for a remote control for interacting with a video programming system are described. In some embodiments, a remote control unit for an intelligent video programming system having user-dedicated buttons, biometric identification systems, mechanical identification systems, electromechanical identification systems, or voice-activation identification systems on the remote control unit to allow a user to self-identify that user to the intelligent video programming system. Upon pressing this user-dedicated button or otherwise activating a self-identification system on the remote control unit, content personalized for that user is presented and the user's navigational behavior is tracked to further the presentation of personalized content for that user. Other embodiments are also described.

### CLAIM OF PRIORITY

This application claims priority to U.S. Provisional Application No. 60/985,173 titled “Remote Control Unit for Intelligent Video Programming System” filed on Nov. 2, 2007, which is incorporated by reference in its entirety.

### RELATED APPLICATIONS

This application is related to U.S. patent application Ser. No. 12/082,955, titled “Viewer Interface for a Content Delivery System” filed on Apr. 14, 2008; U.S. patent application Ser. No. 12/131,009, titled “Programming Content Reconstruction in a Content Delivery System” filed on May 30, 2008; U.S. patent application Ser. No. 12/082,954 titled “A Networked Antenna and Transport System Unit” filed on Apr. 14, 2008; U.S. provisional application Ser. No. 61/016,412 titled “System Architecture For Content Delivery” filed on Dec. 21, 2007, U.S. provisional application Ser. No. 61/016,416 titled “System Architecture For Content Delivery” filed on Dec. 21, 2007; U.S. provisional application Ser. No. 61/016,422 titled “System Architecture For Content Delivery” filed on Dec. 21, 2007; and U.S. Provisional Application No. 61/016,648 titled “System Architecture for Content Delivery” filed on Dec. 26, 2007; and U.S. provisional application Ser. No. 61/016,906 titled “System Architecture For Content Delivery” filed on Dec. 27, 2007.

### TECHNICAL FIELD

The disclosed embodiments relate generally to remote control units, and more particularly, to a remote control unit for an intelligent video programming system.

### BACKGROUND

The general model of delivering of television programming content to viewers is based on a temporal schedule and channels for distributing the content. Generally, to view particular television programming content, a viewer has to find the channel where the particular television programming content is offered and the time at which the television programming content is available for viewing. Viewers receive television programming broadcast through over the air local network television broadcasts and through different tiers of services offered by cable television providers and satellite television providers. And, without subscribing to a cable or satellite provider, a viewer is limited to receiving only local network broadcasts available in a particular region. The viewer is offered different levels of programming services when subscribing to a cable or satellite provider. The more the viewer pays, the more channels of programming content are available to the user. In addition, the subscriber to the cable or satellite services is often offered a pay per view or on-demand service where movies, television program, special features such as certain live events, or other content can be transmitted to the user for viewing for a one-time fee. However, the delivery of content to a subscriber of these cable and satellite service providers is done by one mode of transmission by each provider, such as cable or satellite or wireless broadcast and never a hybrid mode of transmission.

Other non-television based programming provides, such as movies or video-on-demand providers use the Internet as a mode of delivering content. These providers do not deliver any live television programming content, they only deliver pre-recorded television programming, other videos and movies for play back at a viewer's home. In other words, these providers do not deliver live television programming or any sort of linear programming and deliver only non-linear programming, programs that cannot be viewed in real-time, and may be viewable only once after the programming content is downloaded. These providers are limited to transmitting their programming content via the Internet.

In addition to television programming content and on-demand movie content, viewers are also increasingly interested in viewing audio and visual data such as video clips posted by others for sharing on the Internet. There is currently not one service provider available in the market to allow a viewer to view live television, pre-recorded television programming on-demand movie content, and Internet video clips. Many of the current modes of content delivery, such as cable providers, satellite providers, and Internet movie-on-demand providers are expensive. Often, the offerings available to viewers are limited by the mode of delivery that they are set up to receive. Most importantly, with the increasingly dynamic schedules in television viewers' lives, even with the availability of recording devices like digital video recorders (DVRs) and video cassette recorders (VCRs), the current modes of television viewing still do not adequately adapt to the viewing behavior of viewers and what viewers pay does not correlate to the amount of programming content they actually view.

### SUMMARY OF EMBODIMENTS

In some embodiments, a method for displaying content includes, at a receiver controller, receiving user-identifying signals from a user-activated remote control device, using the user-identifying signals to identify a specific user, tracking viewing behavior of the identified user in response to viewing commands received from the user-activated remote control device, selecting personalized content specific to the identified user based on the tracked behavior, and causing the selected personalized content to be displayed.

An alternate method for displaying content includes, at a receiver controller, receiving user-identifying signals from a user-activated remote control device, using the user-identifying signals to identify a specific user, and causing personalized content specific to the identified user to be displayed.

The method further extends to one in which the causing of the personalized content specific to the identified user to be displayed, includes presenting the personalized content in a list on a display device, and selecting the personalized content from the presented list using the user-activated remote control device.

The method further includes tracking actions, including at least one content selection action made using the user-activated remote control device, and using the tracked actions to select the personalized content specific to the identified user.

Yet another method is disclosed for displaying content, this method includes, at a receiver controller, receiving user-identifying signals from a user-activated remote control device, and causing targeted advertising, specific to a user identified by the user-identifying signals, to be presented on a display device.

The method further extends to one where the targeted advertising is inserted into personalized content specific to the identified user for presentation.

The method also extends to one where the targeted advertising is displayed during content fast forward, rewind, and pause operations initiated by the user-activated remote control device.

In some embodiments, a remote control unit is described to have a housing; and a plurality of buttons supported by the housing that include a user button being assignable to a specific user such that selection of the user button causes generation of user identification signals to identify the assigned user, and a group button, in communication with the control circuitry, to allow association with a group such that selection of the group personalizable button causes the remote control device to transmit a signal to cause display of content specific to that specific group.

The remote control may also include a scroll wheel on the body for causing signals to be generated to allow a user to navigate menus for selecting content for display by the video display device.

Another remote control is described to include: a plurality of keys configured to generate signals to communicate with a receiver controller, including: a first key configured to cause transmission of user-identifying signals for identifying a specific user corresponding to the receiver controller, and a second key configured to cause transmission of a group-identifying signal for identifying a specific group of users to the receiver controller and to cause programming content associated with the specific group of users to be displayed on a display device.

An alternative remote control is describe to include circuitry configured to generate control signals for use in communicating user inputs to a video device, a transmitter configured to transmit the control signals to cause the video device to display content, a plurality of control keys each in communication with the control circuitry and respectively adapted to receive a selection of at least one of an associated function from the group of functions consisting of causing display of a home page, causing display of a personalized list of content sources, and causing display of a general list of content sources, a plurality of user buttons, each in communication with the control circuitry to allow one-to-one association between a specific user and a specific one of the plurality of user buttons such that, once the association has been made, selection of a personalizable button causes the remote control device to transmit user identifying signals to cause display of content personalized for the associated user, and a user-activated control pad configured for scroll through and selection of content displayed on the video device.

### BRIEF DESCRIPTION OF THE DRAWINGS

For a better understand of the nature and embodiments of the invention, reference should be made to the Description of Embodiments below, in conjunction with the following drawings in which like reference numbers refer to corresponding parts throughout the figures.

FIG. 1 is a block diagram illustrating an intelligent video programming system in accordance with some embodiments.

FIG. 2 is a diagram illustrating a remote control in accordance with some embodiments.

FIG. 3 is a flow-diagram illustrating a process for creating a new user account on the system in accordance with some embodiments.

FIG. 4 is a flow-diagram illustrating a process for navigating personalized content presented by the set-top box to a user controlling the remote control unit, in accordance with some embodiments.

FIG. 5 is a schematic screenshot of a personal content presentation interface in accordance with some embodiments.

FIG. 6 is a block diagram illustrating an intelligent advertising targeting system in accordance with some embodiments.

### DESCRIPTION OF EMBODIMENTS

This disclosure describes a method and system of interacting with a content delivery system that delivers a variety of audio visual programming data to a viewer. This personalized content delivery system delivers linear content that can be viewed in real-time (as the content is received,) non-linear content such as television programs, movies, etc. that are intended for time-delayed viewing, and video clips shared by others on the Internet. The system and methods described are for a personalized system where content from the content delivery system may be intelligently personalized to the viewer's preference once the viewer has been identified by the content delivery system.

According to some embodiments, a system leveraging digital video technologies has the potential to offer viewers a personalized programming experience. Such a system personalizes the delivery and display of content on display devices such as standard televisions home theaters, and the like, to specific viewers. Such an intelligent programming system would benefit from the ability for the user to self-identify himself/herself to the system. This self-identification allows the intelligent programming system to recognize the content the particular viewer tends to watch and to capture and display relevant content to that viewer. This self-identification also allows the intelligent programming system to target advertising to the identified viewer. Accordingly, there is a need for a remote control unit that works with an intelligent video programming system to allow a user to self-identify himself/herself to the system. Methods for such identification on the remote control unit may include buttons dedicated to identifying the user, systems for biometric identification, or other mechanical, electromechanical, or voice activated means.

Reference will be made to certain embodiments of the invention, examples of which are illustrated in the accompanying drawings. While the invention will be described in conjunction with the embodiments, it will be understood that it is not intended to limit the invention to these particular embodiments. On the contrary, the invention is intended to cover alternatives, modifications, and equivalents that are within the spirit and scope of the invention. The specification and drawings are, accordingly, to be regarded in an illustrative rather than in a restrictive sense.

Moreover, in the following description, numerous specific details are set forth to provide a thorough understanding of the present invention. It will be apparent, however, to one of ordinary skill in the art that the invention may be practiced without these particular details. In other instances, methods, procedures, components, and networks that are well known to those of ordinary skill in the art are not described in detail to avoid obscuring aspects of the present invention.

The disclosed embodiments provide ways for a user to self-identify himself to an intelligent programming system. These self-identification capabilities allow the intelligent programming system to recognize content a particular user tends to watch and to capture and display relevant content to that user. These self-identification capabilities also allow the intelligent programming system to target advertising to the identified user. Methods for such identification on the remote control unit may include buttons dedicated to identifying the user, systems for biometric identification of the user, or other mechanical, biometric, electromechanical, or voice activated systems for identification. For example, in one mode of operation, when a user presses a single user button, which may be a soft key or icon on a touch screen, dedicated to that user, the system powers on and presents to the user content personalized for that user. While the user navigates and views content, the system tracks the user's implicit or explicit viewing preferences, and uses this information to deliver further personal content to the user. In another mode of operation, when a user makes an oral pronunciation of that user's name to the remote control unit, the identity of the speaker is recognized by the remote control or by the personalized and intelligent video programming system such that personalized content can be presented to that user.

Notwithstanding the discrete blocks in the figures, the figures are intended to be a functional description of some embodiments of the invention rather than a structural description of functional elements in the embodiments. One of ordinary skill in the art will recognize that an actual implementation might have the functional elements grouped or split among various components. Moreover, one or more of the blocks in the figures may be implemented on one or more servers and devices designed to provide the described functionality.

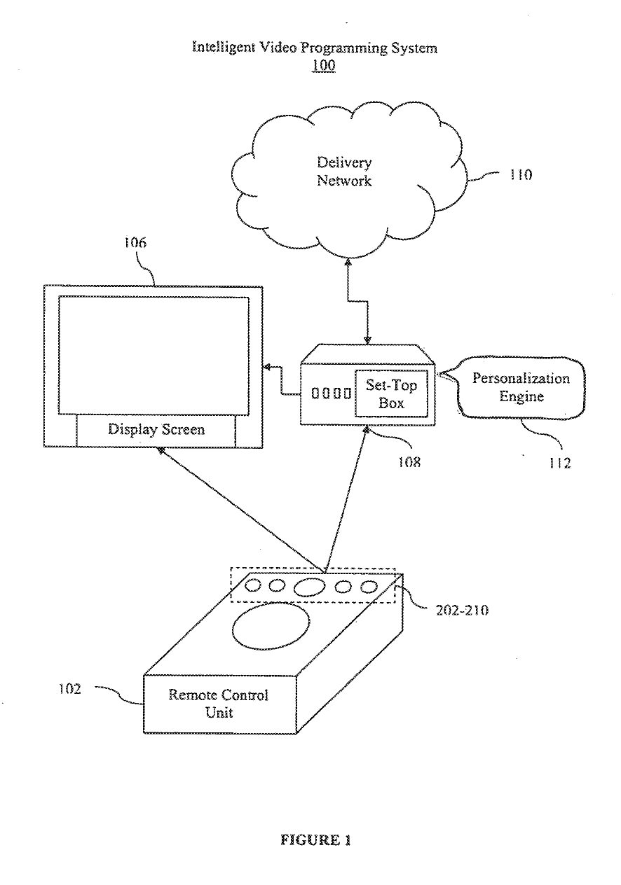

FIG. 1 is a block diagram illustrating an intelligent video programming system in accordance with some embodiments. The intelligent video programming system 100 includes a remote control unit 102, receiver controller/set-top box 108 associated with the remote control unit 102, a display screen 106 that can be configured to the set-top box 108 or the remote control unit 102, and a video delivery network 110 that communicates with the receiver controller/set-top box 108. The remote control unit 102 communicates with the set-top box 108 to indicate a user's selections. The receiver controller/set-top box 108 in turn communicates with the video delivery network 110 to present personalized content to the particular user who is operating the remote control unit 102. Through this communication, personalized content is displayed on the display screen 106. In some embodiments, the delivery network 110 may use a broadcast distribution system, a unicast distribution system, a combination of both, or any other suitable type of signal distribution system to deliver content to the user. In some embodiments the broadcast distribution system includes but is not limited to satellite, terrestrial, cellular or local over-the-air broadcasts. In some embodiments, the unicast distribution system includes a broadband delivery system where a specific content is distributed merely to selected receiver controllers, unlike broadcast distribution which indiscriminately broadcasts to all receiver controllers. The display screen 106 may be any suitable monitor screen and may include a television screen, a computer monitor screen, a portable display screen, or any other such type of screens.

In some embodiments, the intelligent video programming system 100 also includes a personalization engine 112 that tracks a specific user's viewing requests, preferences, and/or behavior while the user interacts with the remote control unit 102 so that the intelligent video programming system 100 can use such data to deliver content personalized for the specific user operating the remote control unit 102. In some embodiments, the personalization engine 112 is located on the set-top box 108. In some other embodiments, however, the personalization engine 112 may be located on the remote control unit 102. Yet in some other embodiments, the personalization engine may be located elsewhere on the system 100. In yet other embodiments, the personalization engine 112 may be distributed over several devices and servers.

It should be appreciated that the system 100 may include a plurality of set-top boxes 108. There may be one or more remote control units 108 associated with each set-top box 108, and there may be one or more users associated with each remote control unit 108. The remote control unit 102 for a particular set-top box 108 may communicate with the set-top box 108 and the display screen 106 in a variety of methods. In some embodiments, the remote control unit 102 uses a bi-directional RF transceiver to communicate with the set-top box 108. The set-top box 108 will use a separate RF transceiver to communicate with the remote control unit 102 in a bidirectional fashion. In some embodiments, communication may flow from the remote control unit 102 to the set-top box 108 to minimize messaging traffic from the set-top box 108 to the remote control unit 102. In some embodiments, the remote control unit 102 will also have an IR emitter to control the display screen 106.

To personalize a particular user's navigation and viewing experience, the remote control unit 102 includes a grouping of user buttons 202-210. Each user button in the grouping of user buttons 202-210 may be dedicated to a specific user and identifies that user to the intelligent video programming system 100. For example, in a household of four, one button may be dedicated to the mother, another button may be dedicated to the father, another button may be dedicated to the daughter, and another button may be dedicated to the son. Pressing one of the user buttons 202-210 dedicated to a particular user logs that user into a personal account dedicated to that user. The set-top box 108 will then present content relevant to that user, and the display screen 106 will display a user interface personalized for that user. As the user views and navigates the user's personal user interface by operating the remote control unit 102, the intelligent video programming system 100 acquires data about the user's viewing selections, preferences, and/or behavior and uses this data to present further personalized content for the user. In some embodiments, tracking is performed by the personalization engine 112 located on the set-top box 108, the remote control unit 102, or some other part of the system 100.

It should be appreciated that in some other embodiments, the remote control unit 102 includes means other than user buttons 202-210 for a user to self-identify himself/herself to the system 100. These means include, but are not limited to, mechanical, biometric (e.g. fingerprint, hand geometry or veins, iris scan, face recognition, ear recognition, odor recognition, or DNA recognition), electromechanical (e.g. use of key cards or RFID), voice activated means, or any other type of means for user self-identification to the system 100. For example, in other embodiments the remote control unit may use a finger print reader instead of the user buttons 202-210.

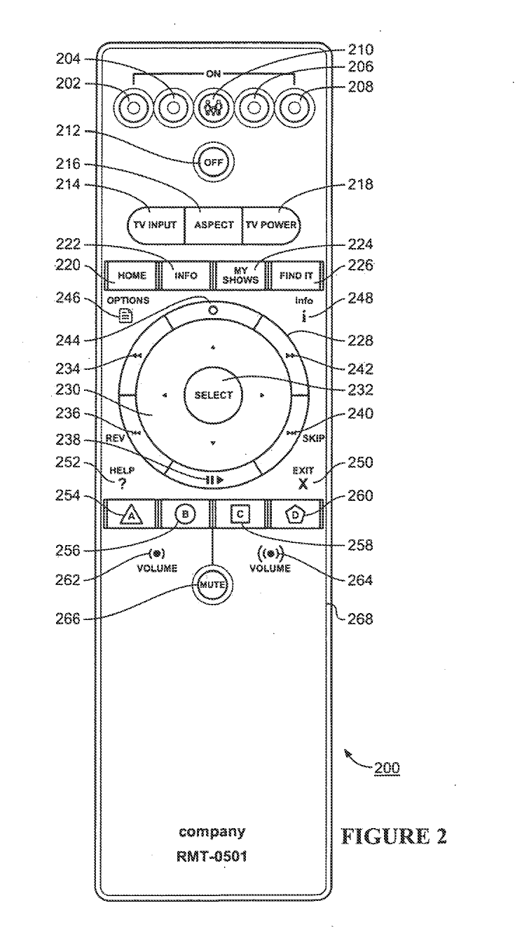

FIG. 2 is a diagram illustrating the remote control unit 102 in accordance with some embodiments. It should be appreciated that the configuration of the buttons or keys on the remote as illustrated is purely exemplary and different arrangements of the buttons are possible in different embodiments. These buttons or keys are mounted on a housing or casing which contains within electrical circuitry for carrying out the functions of the remote control unit 102. In some embodiments, the electrical circuitry includes memory and a processor for executing instructions stored within the memory. The buttons and other interfacing features (E.g., soft keys, scroll pad, scroll wheel etc.) on the housing or casing are electrically coupled to the circuitry such that mechanical actuation of different interfacing features will cause different electrical signals to be generated by the electrical circuitry. The electrical circuitry may be configured in a manner well known to those with ordinary skills in the art to generate electrical signals for communicating with a receiver controller for effectuating a corresponding function at the receiver controller. For example, the electrical circuitry inside the housing or casing controls a transmitter to send these different signals to a set-top box or receiver controller for effectuating these different signals into different functions carried out by the receiver controller. In some embodiments, the electrical circuitry may be powered by batteries or a rechargeable power source. In an embodiment, the transmitter may utilize any one of light signals (e.g., infra-red), radio frequency signals, to communicate with the receiver controller. In some embodiments, the remote control may have a touch screen and soft keys represented by icons on the touch screen. Activation of these icons or soft keys on the touch screen will cause generation of transmission of signals from the remote control.

The various buttons on the remote control unit 102 may be pressed, touched or otherwise activated by the user when operating the remote control unit 102. The grouping of user buttons 202-210 is located at the top of the remote control unit 102. In some other embodiments, the grouping of user buttons 202 is located at some other area on the remote control unit that may be convenient to the user. In one embodiment, the grouping of user buttons 202-210 comprises four individual-user buttons 202-208. In some other embodiments, the grouping of user buttons 202-210 may comprise more or less than four individual-user buttons. The grouping 202-210 further comprises a multi-user, new-user, and/or guest-user button 210 located at the center of the grouping 202-210 or at some other area among the grouping 202-210 that may be easily recognized by the user. In some embodiments, these user buttons 202-210 use metal dome switches and have rigid key caps to help reinforce solid tactile feel. As described above, the user buttons 202-210 may be represented by soft keys or by a touch screen having icons and a touch on the touch screen over the location of the icon will activate a function represented by the icon.

As discussed above in regards to FIG. 1, each individual-user button in the grouping of user buttons 202-210 may be dedicated to a specific user and communicates the presence of that user to the intelligent video programming system 100. When a user presses an individual-user button 202-208 dedicated to that user, the user logs into that user's personal account on the system 100. Each individual-user button 202-208 may also power on the set-top box 108 itself. Therefore, in some embodiments, when the set-top box 108 is in a powered-off state, a user may power on the set-top box 108 and communicate his/her presence to the system 100 by pressing the individual-user button 202-208 dedicated to that user. In some embodiments, the individual-user button 202-208 may be represented by one key or one button which may be used to cycle through different users including groups using a single key or button. In addition, in some embodiments, the display screen 106 can be configured to the set-top box 108 or the remote control unit 102 so that pressing the individual-user button 202-208 also powers on the display screen 106. The display screen 106, which may be on a LCD, plasma, touch screen or other display devices, will then display a welcome screen. In some embodiments, the welcome screen indicates which user has been selected as a result of the button press. In some embodiments, in response to identification of a user, the receiver controller or set-top box may also have the capability to filter out content that is not relevant to the user.

If the number of users exceeds the number of individual-user buttons 202-208 available and each individual-user button 202-208 has already been dedicated to a specific user, then an additional user may log in to that user's personal account by pressing the multi-user button 210. Similar to pressing an individual-user button 202-208, pressing the multi-user button 210 when the set-top box 108 is in a powered-off state will power on the set-top box 108. In some embodiments, the display screen 106 can be configured to the set-top box 108 or the remote control unit 102 so that pressing the individual-user button 202-208 also powers on the display screen 106. The display screen 106 will then display a list of accounts for the user to choose from along with icons representing their corresponding user buttons 202-210.

For example, in some embodiments, if a user is a guest to the household and would like to log in under the family user account, the guest user can press the multi-user button 210 to display a user selections menu on the display screen 106. From that screen, the guest user may choose to log in under the family user account by highlighting that option with the scroll wheel 228 or and pressing the select button 232. In some embodiments, the display screen 106 may also display an “Add New User” option so that the guest user may select to add a new user account. To access that account again, the guest user may press the multi-user button 210 and then select to log in to that account by using the scroll wheel 228.

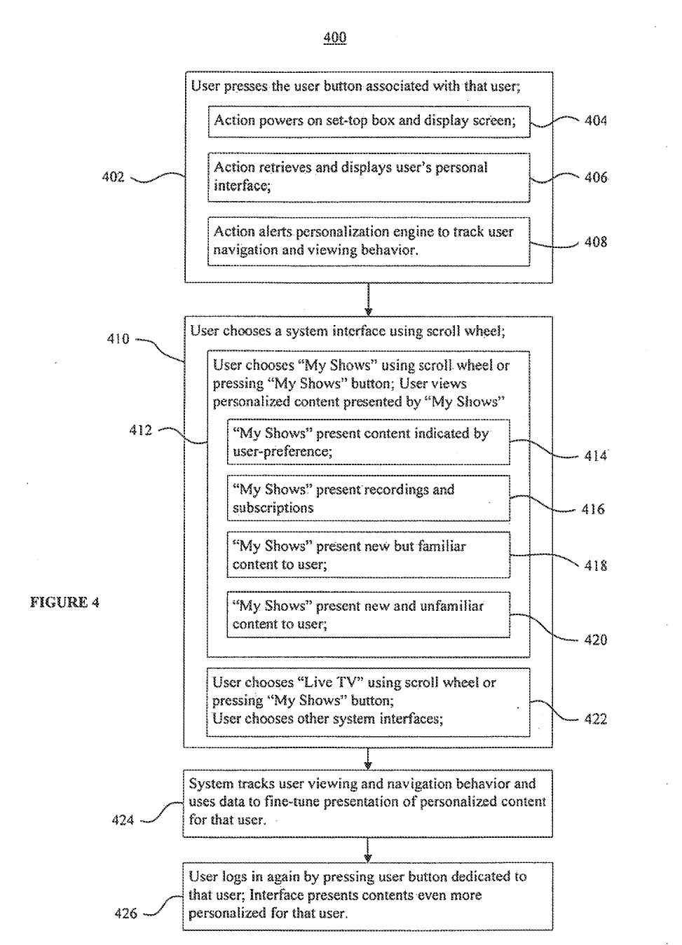

As discussed below in regards to FIG. 4, once the user has logged into that user's account by pressing the user's dedicated individual-user button 202-208 or by pressing the multi-user button 210, the user's personal user interface and personalized content will be presented to the user. This assumes that the specific user is operating the remote control unit 102 to navigate and view content and no other user is operating the control unit 102 to switch to a different user account by pressing a different individual-user button 202-208 or by logging in via the multi-user button 210. In addition, as long as the specific user is logged into that user's account and is navigating through the specific user's personal user interface, the system 100 will track viewing data associated with that user, including but not limited to that user's recordings, subscriptions, ratings, preference entries, as well as that user's navigation and viewing patterns. In some embodiments, the set-top box 108 will use this data to capture relevant content from the delivery network 110 for that user. The system 100 may also use this tracked viewing data to present content that the system 100 predicts will be relevant to that user.

To ease user recognition that a particular individual-user button 202-208 is dedicated to a particular user, the individual-user buttons 202-208 may be differentiated by color, shape, size or other recognizable indicia. To ease user recognition of the multi-user button 210, the multi-user button 210 may also be differentiated from the individual-user buttons 202-208 by color, shape, size or other recognizable indicia. For example, in some embodiments, the user buttons appear in five distinct colors such as green, yellow, red, blue, and purple. In one embodiment, the multi-user button 210 is colored red and is larger than the individual-user buttons 202-208, which may all be of the same size. Furthermore, the user buttons 202-210 may include icons to aid user recognition of their functions. For example, in some embodiments, the individual-user buttons 202-208 are labeled by an icon depicting a single viewer whereas the multi-user button 210 is labeled by an icon depicting multiple viewers. The recognizable indicia may vary from implementation to implementation.

Located below the user buttons 204-210 is an off button 212 that may act to power off the set-top box 108. In some embodiments, if the user has configured a particular display screen 106 to the set-top box 108 or the remote control unit 102, pressing the off button 212 may also power off the display screen 106. Thus, a user may power on the set-top box 108 and the display screen 106 by pressing the individual-user button 202-208 dedicated to that user or by pressing the multi-user button 210, and the user may power off the set-top box 108 and the display screen 106 by pressing the off button 212. In some other embodiments, however, the off button 212 or a similar button may serve both power-on and power-off functions. Similar to the location of the other buttons discussed above in regards to FIG. 2, the off button 212 may be located at some other area of the remote control unit 102 that will be convenient to the user.

Located below the off button 212 is a group of display screen control buttons 214-218. In some embodiments, the screen controlling buttons comprise an aspect or zoom button 216, a TV power button 218, and a TV input button 214. The TV power button 218 and the TV input button 214 control properties of the display screen 106 to which the set-top box 108 is connected. The aspect or zoom button 216 controls the display format of the video output to the display screen 106. For instance, the zoom button 216 allows the user to resize or zoom into the image on the display screen 106. In some embodiments, these display screen buttons 214-218 use metal dome switches and have rigid key caps to help reinforce solid tactile feel. Similar to the location of the other buttons discussed above in regards to FIG. 2, in some other embodiments, these display screen buttons 214-218 are located at some other area of the remote control unit 102 that may be convenient to the user. In some embodiments, these display screen buttons 214-218 may be located on a touch screen.

Located below the display screen buttons 214-218 are a group of mode buttons 220-226. In some embodiments, these mode buttons 220-226 comprise a “Home” button 220, a “Live TV” button 222, a “Find It” or “All Sezmi” button 224, and a “My Shows” or “My Sezmi” button 226. The specific functionalities of these buttons are explained in detail below. These mode buttons 220-226 may be pressed by the user to navigate to a specific starting point in the user's personal interface on the display screen 106. It should be appreciated, however, that these mode buttons 220-226 are included in the remote control unit 102 for convenience and may not be necessary to the user's navigational needs, according to some embodiments. The user may also navigate to those specific starting points in the user's interface by using the scroll wheel 228. In other embodiments, other buttons such as “Surf” and “History” (not shown), or buttons that embody different functions may be included.

In some embodiments, the mode buttons 220-226 are situated in a direct line on the remote control unit 102, or on a touch screen, and separated by narrow gaps not to exceed 0.5 mm. In one embodiment, because the mode buttons 220-226 are closely situated in a direct line, they may be distinguished from each other by feel, using a convex contour on the top surface of each mode button 220-226. In some embodiments, the mode buttons 220-226 use metal dome switches and have rigid plastic key caps in a color that can be easily distinguished. Similar to the location of the other buttons discussed above in regards to FIG. 2, in some other embodiments, the mode buttons 220-226 are located at some other area of the remote control unit 102 that may be convenient to the user.

Located at the center of the remote control unit 102 is the scroll wheel 228. In some embodiments, the scroll wheel 228 comprises a circular scroll pad 230, a set of four-way directional arrow buttons integrated into the scroll pad 230, and a select button 232 situated at the center of the scroll wheel 228. The scroll pad 230 may be a capacitive touch sensing scroll pad or any other type of touch sensing scroll pads. In some embodiments, the scroll wheel 228 is covered by a thin layer of “nameplate material” to protect the scroll pad 230 and to cover the center select button 232. In some embodiments, arrow icons are printed on the nameplate and the word “Select” is printed on the select button 232. The scroll pad 230 encodes clockwise and counterclockwise rotation as the user slides a finger or thumb around the scroll wheel 228 in either direction. The remote control unit 102 translates this action into navigation commands on the display screen 106. For example, the sliding action around the scroll wheel 228 corresponds to the movement of a highlight cursor up or down a selection list displayed by the display screen 106.

In some embodiments, the scroll wheel 228 is mounted on a rocker switch mechanism having switches in the four cardinal directions. Thus, light touches on the scroll pad portion 230 of the scroll wheel 228 can send rotational commands. Pressing down on the top, bottom, left, or right portions of the scroll wheel 228 (the areas corresponding to the set of four-way directional arrow buttons built into the scroll pad 230), however, generates a directional command. The remote control unit 102 then translates these scrolling or pressing actions into navigational commands on the display screen 106. Once the scrolling or pressing action has stopped and an item is highlighted on the display screen 106, the user can press the select button 232 at the center of the scroll wheel 228 to select or activate this item. For maximum navigational accuracy, the activation force of the rocker switching action under the scroll wheel 228 should be firm enough so that a rotational scrolling action does not accidentally trigger the rocker switches, but yet light enough so that no undue force is required to activate the rocker switches. Similar to the location of the other buttons discussed above in regards to FIG. 2, the scroll wheel 228 may be located at some other area on the remote control unit 102 that will be convenient to the user. The scroll wheel 228 may also take on other configurations without departing from the scope of the invention.

Surrounding the scroll wheel 228 is a control ring of buttons 234-244. In some embodiments, the control ring of buttons 234-244 comprise six buttons: a play or pause button 238, a skip forward button 240, a skip back button 236, a rewind button 234, a fast forward button 242, and an “Actions” button 244. The control buttons 234-242 control the timing of the content currently being viewed. In some embodiments, the skip forward button 240 or the skip back button 236 allows a user to skip forward or backward in three speeds with adaptive recovery. In other embodiments, a user can press the skip forward button 240 to skip forward 10, 20, or 30 seconds into the content or hold down the skip forward button 240 to jump to the end of the content. Alternatively, a user can hold the skip back button 236 to skip backwards 10, 20, or 30 seconds or hold down the skip back button 236 to jump to the beginning of the content, for example. In some embodiments, slow motion may be achieved by pressing both the pause button 238 and the fast forward button 242. In some embodiments, single frame advance may be achieved by pressing both the pause button 238 and the skip forward button 240 or the skip back button 236. As the user adjusts the timing of the content, a status bar may be displayed on top of the content to alert the user to the content's location in time.

In addition to the five control buttons 234-242, the control ring of buttons 234-244 includes an “Actions” button 244 to allow the user to make certain preference related actions for the particular content that the user is viewing. In some embodiments, pressing the “Actions” button' 244 displays an Actions menu on any piece of content regardless of whether the user was viewing the content in full screen or viewing the content in a smaller video screen while browsing through other content. In some embodiments, the “Actions” button 244 is positioned at the top of the control ring so as to be easily accessible by the user. In some other embodiments, the “Actions” button 244 may be located at some other are on a remote control unit 102 that will be convenient to the user.

Once the user has pressed the “Actions” button 244, the Actions menu will display a list of commands. In some embodiments, the list of commands includes items such as “Rate Program or Series,” “Record Program or Series,” “Subscribe or Unsubscribe to series,” “Add to Play List,” “Save in Archive,” or any other similar types of preference related action commands. Using the scroll wheel 228, the user may then select to rate the program, record the program, record the program on an ongoing basis, add the program to the user's personal play list, or keep the program. In addition, any action that the user selects to perform by using the scroll wheel 228 will be tracked and used by the system 100 to fine-tune the presentation of personalized content for that user operating the remote control unit 102.

In some embodiments, all six control ring buttons 234-244 use metal dome switches and have rigid plastic key caps to reinforce a solid tactile feel. In certain embodiments, the key caps of the six buttons 234-244 are separated by narrow gaps not to exceed 0.5 mm. For maximum navigational accuracy, the action of any button in the control ring of buttons 234-244 should not interfere with the rocker switch action associated with the scroll wheel 228. Similar to the location of the other buttons discussed above in regards to FIG. 2, the control ring of buttons 234-244 may be located at some other area on the remote control unit 102 that will be convenient to the user. The control ring of buttons 234-244 may also take on other functions and configurations without departing from the scope of the invention.

According to certain embodiments, surrounding the scroll wheel 228 and the control ring of buttons 234-244 is a plastic, non-metal, or otherwise flexible (“plastic”) top-case piece 268. Positioned at the four corners of the plastic top-case piece 268 are four user interface (“UI”) feature buttons 246-252. These four UI feature buttons 246-252 provide dedicated control of commonly used or important features of the intelligent video programming system 100.

In some embodiments, the UI feature buttons 246-252 are described as follow: An options button 246 that provides access to context-dependent operations related to the video currently playing on the display screen 106; (In some embodiments, pressing the options button 246 button will display a menu of commands, including items such as “Play from beginning,” “Parental controls,” “Audio language,” and “Closed captions.”); an information button 248 that displays program information overlays; an exit button 250 that clears any on-screen displays and returns the user to watching full-screen video; and a help button 252 that provides access to context-sensitive help for the user.

In some embodiments, these UI feature buttons 246-252 use metal dome switches but do not use rigid key caps. In some other embodiments, however, the UI feature buttons 246-252 may use both metal dome switches and rigid key caps. The Metal dome switches for the UI feature buttons 246-252 are positioned directly underneath the plastic top-case piece 268 on which the four UI feature buttons sit. To activate the metal dome switches positioned underneath these four UI feature buttons 246-252, a user presses down on the plastic top-case piece 268 surrounding the scroll wheel 228 and the control ring 234-244. For maximum navigational accuracy, the UI feature buttons 246-252 should have the appropriate amount of travel and tactile click.

Located below the scroll wheel 228 and the transport control ring 234-244 are a group of soft buttons 254-260. The soft buttons 254-260 have different functions depending on the particular interface that a user is navigating. For example, in some embodiments, the soft buttons 254-260 may be used for password entry. This occurs when a user has chosen to protect that user's account upon login with a password. When the user presses the user button 202-208 dedicated to that user or presses the multi-user button 210 to select the user's account, a password prompt will appear on the display screen 106. Passwords consist of a combination of presses to the soft-buttons 254-260. For example, if the soft buttons 254-260 are labeled A, B, C, and D, then passwords will consist of a combination of those letters.

In some embodiments, the group of soft buttons 254-260 matches the row of mode buttons 220-226 in shape, color, form factor, and tactile feel. In some embodiments, the soft buttons 254-260 are labeled A, B, C, and D and have distinctly shaped icons. Similar to the location of the other buttons discussed above in regards to FIG. 2, in some other embodiments, the soft buttons 254-260 are located at some other area of the remote control unit 102 that may be convenient to the user.

Located below the group of soft buttons 254-260 are a set of audio control buttons 262-266. Again, similar to the location of the other buttons discussed above in regards to FIG. 2, in some other embodiments, these audio control buttons 262-266 are located at some other area of the remote control unit 102 that may be convenient to the user. In some embodiments, if the user has configured a particular display screen 106 to the set-top box 108 or the remote control unit 102, pressing the audio buttons 262-266 will send IR codes to that display screen 106. Otherwise, pressing the audio buttons 262-266 will control audio outputs on the set-top box 108.

In some embodiments, the audio control buttons 262-266 include a volume up button 262, a volume down button 264, and a mute button 266. In some embodiments, the audio control buttons 262-266 use metal dome switches but do not use rigid key caps. In some other embodiments, however, the audio control buttons 262-266 use both metal dome switches and rigid key caps. The metal dome switches are positioned directly underneath the plastic top-case piece 268 on which the audio control buttons 262-266 sit. To activate the metal dome switches positioned underneath, a user presses down on the plastic top-case piece 268 surrounding the scroll wheel 228 and the control ring 234-244. For maximum control accuracy, the audio control buttons 262-266 should have an appropriate amount of travel and tactile click.

The remote control unit 102 may include other buttons to facilitate a user's navigation and viewing experience. To simplify a user's personalized navigation and viewing experience, however, a user may interact with the system 100 by using the particular user button 202-210 dedicated to that user and the scroll wheel 228. It should be appreciated that in some embodiments, the remote control unit 102 may not include any numerical buttons. When the user presses the particular individual-user button 202-208 dedicated to that user or when the user presses the multi-user button 210 to select the user's account, that user's personal account activates and causes the user's personal interface to appear on the display screen 106. From then on, the user may use the scroll wheel 228 to navigate the user interface menus presented for that particular user. As the user navigates through the user's personal user interface with the remote control unit 102, the system 100 tracks that user's viewing preference data and uses this data to further present personalized content to the user. For new users to the intelligent video programming system 100, the process of creating a user account may still be carried out with one of the user buttons 202-210 and the scroll wheel 228.

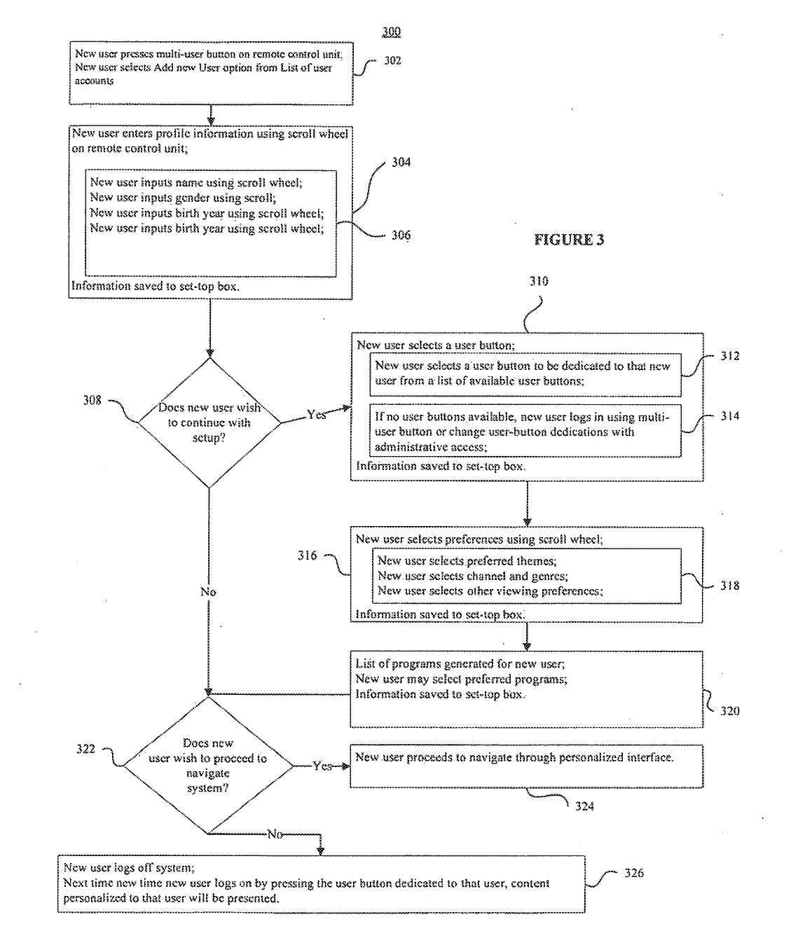

FIG. 3 is a flow-diagram illustrating a process 300 for creating a new user account on the system 100 using the remote control unit 102, in accordance with some embodiments. A new user presses the multi-user button 210 on the remote control unit 102 (302). If the set-top box 108 is in a powered-off state, this action powers on the set-top box 108. In some embodiments, if a particular display screen 106 is configured to the set-top box 108 or to the remote control unit 102, this action also powers on the display screen 106. A list of user accounts will then appear on the display screen (302). If, however, the set-top box 108 and the display screen 106 are already powered on, meaning that some other user is currently viewing content personalized to that other user and the current user interface is tailored specifically to that other user, pressing the multi-user button 210 switches the screen to a list of user accounts associated with the set-top box 108 (302).

Using the scroll wheel 228, the new user may scroll among the list of users to select an “Add New User” option (302). This action alerts the set-top box 108 that a new user account will be added to the system 100. A new user setup screen will then appear on the display screen 106 prompting the new user to enter the new user's profile information (304). The new user can input a name by using the scroll wheel 228 to select among letters of the alphabet (306). The new user does so by using the scroll wheel 228 to highlight a letter and then pressing the select button 232 to make an entry. To proceed to the next user setup screen, the new user can press the right arrow button among the four-way directional arrow buttons integrated into the scroll pad 230. To go back to the previous screen, the new user can press the left arrow button among the four-way directional arrow buttons integrated into the scroll pad 230. On the next new user setup screen, the new user can input a birth year, for example, by using the scroll wheel 228 to select numbers among a list (306). As another non-limiting example, the new user can also input a gender by using the scroll wheel to select among genders (306). In some other embodiments, the new user can input additional profile information using the scroll wheel 228. User profiles are saved to the set-top box 108 (306). In other embodiments, user profiles are saved on the remote control unit 102.

Once the new user has entered the initial profile information using the scroll wheel 228, the next screen will give the new user an option to skip or to continue with further setup (308). In some embodiments, the screen will indicate to the new user that skipping the setup process is not preferable because the system will not be able to guarantee the best possible viewing experience for that user. If the new user chooses to continue with setup by pressing the right arrow button integrated into the scroll pad 230, the screen will display a list of icons corresponding to the available individual-user buttons 202-208 (310). The new user can then use the scroll wheel 228 to select among the individual-user buttons 202-208 available (312). The information is saved to the set-top box 108 (312), or to the remote control unit 102. An individual-user button 202-208 is available if it has not already been dedicated to another user. After the new user has dedicated an available individual-user button 202-208 to that user, all information personal to that user will be associated with that selected user individual-user button 202-208. The user may then log into the system 100 by pressing that particular individual-user button 202-208. Once the user logs in, the user's navigation and viewing experience will be unique to that user.

If no individual-user buttons 202-208 are available to be dedicated to the new user, then the new user may choose to login using the multi-user button 210 (314). Again, the information is saved to the set-top box 108 (312). The new user will then be able to login by pressing the multi-user button 210. This action displays a user account menu on the display screen 106. In some embodiments, the user account menu screen lists the user accounts currently associated with the set-top box 108 along with icons representing their corresponding user buttons 202-210. From that menu, the new user may choose to login under that user's account by highlighting that option with the scroll wheel 228 and pressing the select button 232. From then on, as long as the user is logged into that user's account, that user's navigation and viewing experience will be unique to that user. In some embodiments, the new user may also change user button dedications if that new user has administrative or other appropriate access rights.

After selecting a user button 202-210, the new user can proceed with further setup by using the scroll wheel 228 to choose from various personal preference options (316). The information is saved either to the set-top box 108 (316) or to the remote control unit 102. The user may choose among various colors, designs, skins, avatars, or other additional themes to be displayed on that user's personal user interface (318), for example. Skins are custom graphical appearances that may include designs, animated backgrounds, sound effects, or other graphical or musical themes. Avatars are graphical representations of the user associated with the remote control'unit 102 and may be animated or customized to that user's wishes. Once the new user has selected the colors, designs, skins, avatars, or other themes for that user's personal interface, these selections will be saved to the set-top box 108, or to the remote control unit 102, and will be displayed every time the user logs into that user's account. For example, the next time the user logs into h account by either pressing the specific individual-user button 202-208 dedicated to that user or by pressing the multi-user button 210, that user's themes will be displayed throughout the user interface and will continue to be displayed for the duration of his/her viewing and navigation experience.

After choosing the preferred themes to be displayed for the user's personal user interface, the new user may also use the scroll wheel 228 to select among channels, genres, or other viewing preferences (318). Once the new user has selected these viewing preferences, a list of programs generated from these preferences will appear on the screen (320). The new user may then use the scroll wheel 228 to check or uncheck programs that the user prefers (320). The system 100 tracks these preferences so that the set-top box 108 will know what content to capture from the delivery network 110 for that user. Once the new user has finished with all the prompted selections, a “Setup Complete” screen will appear. In some embodiments, the “Setup Complete” screen displays the user's name and an icon for the user button 202-210 dedicated to that user. The user may continue navigating through the user interface created for him/her or log off and log back in to the system 100 at some other time (322). If the new user chooses to log off by either allowing another user to press a dedicated individual-user button 202-208 or multi-user button 210 or by pressing the off button 212 or any other similar power-off button, the next time this particular user logs into his/her account by pressing the dedicated individual-user button 202-208, all themes and preferences will be retrieved and displayed for the duration of his/her viewing experience (236). According to some embodiments, if the user does not select personal preference options and/or viewing preferences, default options may be used.

FIG. 4 is a flow-diagram illustrating a process 400 for navigating personalized content presented by the system 100 to a user controlling the remote control unit 102, in accordance with some embodiments. Once an individual-user button 202-208 has been dedicated to a user, the user may log into his/her personal account on the system 100 by pressing that dedicated user button 202-208 (402). In the alternative, once a user has created an account and no individual-user buttons are available, the user may log into that user's personal account by pressing the multi-user button 210 (402). If the set-top box 108 is in a powered-off state, pressing the dedicated user button 202-210 powers on the set-top box 108 (404). In some embodiments, if a particular display screen 106 is configured to the set-top box 108 or to the remote control unit 102, this action also powers on the display screen 106 (404). The set-top box 108 will then retrieve and display his personal interface (406).

If the set-top box 108 and the display screen 106 are already powered on, meaning that some other user was previously viewing content personalized to that other user, pressing the current user's dedicated user button 202-208 will switch the screen to display the current user's personal user interface (406). The user's personal user interface will present content that is tailored specifically for that user and will present such content in ways that are specifically tailored for that user. For example, in some embodiments, the system 100 may select certain shows that the system 100 predicts the user will enjoy. Such selected shows may appear at the top or bottom of a user interface stack personalized for that user, or be intermixed with other content. In addition, the user's personal user interface will include the specific colors, designs, skins, avatars, and/or other themes that the user has selected during account setup.

Once the user has logged into his/her account by pressing the user's dedicated user button 202-210, as long as that user is using the remote control unit 102 to navigate and view content, meaning that as long as no other user switches to a different account by pressing another user button 202-210, content personalized to that user will be displayed (406). In addition, as long as that user is logged into his/her personal account and is navigating through the user's personal user interface, the system 100 will track data associated with that user, including but not limited to his/her recordings, subscriptions, ratings, preference entries, as well as his/her navigation and viewing patterns (408).

Because there may be multiple users and multiple set-top boxes 108 in the system 100, the system 100 will track data for each user while that user is logged into the system 100. In some embodiments, the system 100 uses an aggregation of user-specific data tracked by the system 100 to determine what content to distribute to the set top boxes 108 in the system 100, at what time to make the distribution, and over what delivery mechanism to make the distribution. This personalized content may be content that the user is already familiar with, such as episodes of shows that the user is known to have viewed in the past, or may be recommended content that the user is unfamiliar with but may nevertheless enjoy.

In some embodiments, the system 100 uses a broadcast distribution system, a unicast distribution system, or a combination of both types of distribution systems to distribute content to the set top boxes 108. For broadcast distribution of content, the user-specific data tracked by the system 100 may be used to determine what content is to be selectively captured by the set-top box 108 from the broadcast distribution and in turn presented to the user operating the remote control unit 102 associated with the set-top box 108. For unicast distribution of content, the user-specific data tracked by the system 100 may be used to determine what content to selectively push to the set top box 108 and what content to be selectively pulled down by the set-top box 108 for the user operating the remote control 102 associated with the set-top box 108. The next time that user logs into the system 100 by pressing the dedicated user button 202-210, the set-top box 108 will present this personalized content as viewing options for him.

Having logged into that user's account either by pressing the user's dedicated user button 202-210 or otherwise, the user may choose from various system interfaces for viewing content by either using the scroll wheel 228 to navigate through interface menus or by pressing one of the mode buttons 220-226 at any time to proceed directly to that particular interface (410). In some embodiments, major system interfaces for viewing content include, but are not limited to, “My Shows,” “Live TV,” “Find It,” and “Home” or any other similar interface options.

The “My Shows” interface or any other similar interface carries all shows, movies, and other programs personalized for the user. In some embodiments, the “My Shows” interface may be divided into channels and other subcategories to ease user navigation. For example, in one embodiment, the “My Shows” interface may include sub-categories such as: “Top Picks” containing selections the system 100 predicts will be most relevant to the user; “What's New” containing shows that have been downloaded for that user within a recent time period; “Categories” containing shows broken out into various genres; “My Channels” containing all channels, including channels that present content to the user in real time and channels that does not present content to the user in real time; “My Movies”; “My Web Picks” containing web clips grouped by specific third-party services (i.e., Yahoo, YouTube, AOL, etc); “My Playlist”; and “My Keep List” containing all programs that the user has expressed a desire to keep for any specified amount of time.

In some embodiments, a “Surf” button may allow activation of a reduced version of “My Shows” or “My Sezmi” on the display, overlaying programming content such that a user may select programs while enjoying content that is currently playing. In other embodiments, a “History” button may allow activation of a dialogue or list overlaying at least a part of the currently playing program. The dialogue may display information about one or more menu items or programs that have previously been played.

In some embodiments, the “Live TV” or any other similar interface carries channels that present content to the user in real time. In other words, activation of “Live TV” button allows a viewer to select different programming content available on live television for viewing. These channels may include local real-time channels accessible by the public as well as real-time channels served by the delivery network 110 at the time the user is logged into his/her account after pressing the dedicated user button 202-210.

In some embodiments, the “Home” interface or any other similar interface allows the user to change settings, whether global or specific, to that user, and monitor scheduled recordings and series. In some embodiments, the “Find It” or “All Sezmi” interface or any other similar interface allows the user to find shows, movies, or other programs that the set-top box or receiver controller 108 did not capture for the user and that the user wishes the set-top box or receiver controller 108 to capture, either currently or in the future. In some embodiments, the “All Sezmi” or “Find it” button 224 displays all of the available programming choices to the user, including both live TV and time-delayed content which may be stored in memory. The time-delayed content may include programming content selected by a user or recommended to a user. The user may choose from any of these interfaces by either using the scroll wheel 228 or by pressing the corresponding mode button 220-226.

To watch content personalized for that particular user, the user may press the “My Shows” button 224 or navigate to the “My Shows” interface by using the scroll wheel 228 (412). The “My Shows” interface or any other similar interface carries all shows, movies, and other programs personalized for the user who pressed the dedicated user button 202-210 on the remote control unit 102, according to some embodiments. Personalized content may include content played in real time, content previously recorded for the user, content previously captured for the user from the delivery network 110, or any other type of personalized content. In some embodiments, these shows, movies, or other programs are presented in a menu structure across multiple high level channels or categories. In some embodiments, the menu structure may appear as a stack, and lists the various channels and categories in which the personalized content is contained. The user can then drill down to the desired channels or categories by using the scroll wheel 228 and further select the desired content by again using the scroll wheel 228, for example.

As discussed above in regards to operation 408, personalized content for a user is generated based on information the system 100 has tracked from that user's viewing preference and behavior, whether currently logged in or previously logged into the system 100. The personalized content is in turn presented to the user by the receiver controller/set-top box 108 when that user presses the dedicated user button 202-210.

To determine what personalized content to include in the “My Shows” interface for a particular user, the system 100 uses data gathered while the user is currently logged in or when that user was previously logged in. In some embodiments, this user-specific data is gathered from user recordings, user subscriptions (where the user asks the receiver controller/set-top box 108 to record a program on an on-going basis), user ratings, manual entry of user preferences, and modeling of user navigation and viewing behavior. It should be appreciated that user-specific data may be gathered in other ways without departing from the scope of the invention.

The user may manually indicate to the receiver controller/set-top box 108 which channels, genres or programs the user prefers. This can occur, for example, during the user's account setup or at any other time the user wishes to enter that user's preferences. These user indicated programs will appear in the “My Shows” interface (414). The system 100 will also track this data for the user. The user may also indicate to the receiver controller/set-top box 108 to record certain programs for that user. For example, while watching a show in real time, the user may ask the receiver controller/set-top box 108 to record the show for that user by pressing the “Actions” button 244. In some embodiments, the user may also ask the receiver controller/set-top box 108 to record a program in the future by pressing the options button 246 or some other similar button and then selecting the record option by using the scroll wheel 228. The recorded program will appear in the “My Shows” interface (416). The system 100 will also track this data for that user. Alternatively, the user may ask the receiver controller/set-top box 108 to record the series for that user on an on-going basis, again by pressing the “Actions” button 244 while viewing a show in real time or by pressing the options button 246. Again, these recorded programs will appear in the “My Shows” interface (416). The system 100 will also track this data for that user. In addition, the user may rate a certain program, meaning that the user may indicate to the receiver controller/set-top box 108 that the user likes that program. For example, while watching certain content, the user may press the “Actions” button 244 to select the rating feature among the Actions menu. The system 100 will track these actions and selections for the user who pressed the dedicated user button 202-210 on the remote control unit 102.

The system 100 then uses these user-specific data to present personalized content to the user. For example, the user may have indicated to the receiver controller/set-top box 108 an episode of a show that the user wishes the set-top box 108 to record. This information is tracked by the system 100. The set-top box 108 will then record the episode for that user. Next time the user logs in to the system 100, the episode will be available on the set-top box 108 to be presented to that user. Because the system 100 has tracked that this user has previously recorded the show, it will notify the receiver controller/set-top box 108 to capture this show on an ongoing basis for that user. As they are captured, episodes of the show will become available in the “My Shows” interface or a similar interface designed to present personalized content every time that user logs in to the system 100.

Furthermore, when the user logs in to the system 100, the system 100 may model the user's viewing and navigation behavior. In some embodiments, the system 100 models the user's viewing and navigation behavior by tracking what programs the user chose to watch and what choices the user was presented with leading up to the user's eventual viewing choice. This type of choice modeling may be implemented in a variety of ways. In one embodiment, when the user has been browsing through content and has been presented with a certain show that he/she eventually views, the system 100 counts this as a “hit” for that show. At the same time, the system 100 counts all other content displayed somewhere else in the interface as “misses.” If the viewer chooses not to watch any of the content presented, the system 100 counts such an event separately and treats them differently than “misses.” The system 100 thus learns what the user has watched and what the user has not watched and follows that learning for that particular user.

The system 100 may use this user-specific data to present programs that the user is already familiar with, but has not yet viewed via the “My Shows” interface (418). For example, the system 100 may have learned that a user chose to watch episodes of a certain series on more than one occasion. The system 100 will then automatically capture the series on an on-going basis for that user. These episodes will then be presented via the “My Shows” interface as they occur in the future. In addition to content that the user may already be familiar with, the system 100 may also use tracked data to present new and unfamiliar content that the system 100 predicts the user will enjoy (420). Again, the predicted content may be presented to the user via the “My Shows” interface when that user logs in.

In addition to choosing the “My Shows” interface, the user may choose the “Live TV” interface to watch channels presented to that user in real time. The user may navigate to the “Live TV” interface by using the scroll wheel 228 or by pressing the “Live TV” mode button 222 (422). The presentation of these channels may be personalized to that particular user who pressed the user button 202-210 dedicated to that user. In the situation where the user does not have a dedicated individual-user button, the user will have logged into that user's account by pressing the multi-user button 210 and by selecting the appropriate user account with the scroll wheel 228. In any case, when that user navigates to the “Live TV” interface, the channels and programs presented may be those for which the user has indicated a preference or those that the system 100 predicts the user will prefer. For example, when that user was previously logged into his/her account by pressing the user button 202-210 dedicated to him/her, he/she has indicated to the set-top box 108 which channels and programs that the user prefers. When the user logs on this time and navigates to the “Live TV” interface, those indicated channels may be presented first in preferred order.

While the user navigates and views content, regardless of which content presentation interface the user may be interacting with, the system 100 will continuously fine-tune the presentation of personalized content for the user as it receives updated tracking data associated with that user (424). Again, such tracking data may include that user's recordings, subscriptions, ratings, preference entries, as well as that user's navigation and viewing patterns. Each time the user logs in and performs some action, the system 100 tracks that action so that the system can use newly gathered user data to refine predictions with respect to presenting content personalized for that user (426).

For example, the user logs in by pressing the individual-user button 202-208 dedicated to him/her and navigates to the “Live TV” interface or the “My Shows” interface by using the scroll wheel 228 or by pressing the corresponding mode button 220-226. The user then decides to browse through channels personalized for that user by navigating the channels and contents under the “Live TV” interface or “My Shows” interface. While browsing, the user is presented with options to watch “Law and Order,” “Masterpiece Theater,” “NBA Playoffs,” and “The Office.” Using the scroll wheel 228, the user selects to watch “Law and Order.” After several minutes, however, the user retreats from watching “Law and Order” and selects to watch “The Office” using the scroll wheel 228. After finishing the entire episode of “The Office,” the user logs off by pressing the off button 212. The system 100 tracks this sequence of events while the user was logged on. The system 100 notes that the user eventually watched “The Office” in its entirety, only watched “Law and Order” for several minutes, and never watched “Masterpiece Theater” or “NBA Playoffs.” The system 100 then uses this information to predict that this particular user would most likely also wish to watch “Thirty Rock,” another office-based comedy TV show similar to “The Office,” for example. The system 100 does so even though that user is not familiar with the show “Thirty Rock,” nor has that user requested the set-top box 108 to record or to capture that show. The next time the user logs on by pressing the dedicated individual-user button 202-208, the show “Thirty Rock” will be presented to the user via the “My Shows” interface. If the show is playing in real time when that user is logged in, the user may also access the show via the “Live TV” interface. The system 100 will then track whether or not and for how long the user watches “Thirty Rock.” This information is in turn used by the system 100 to fine-tune the presentation of personalized content for that user.

In another example, the user logs in by pressing the individual-user button 202-208 dedicated to him/her and navigates to the “Live TV” interface or the “My Shows” interface by using the scroll wheel 228 or by pressing the corresponding mode button 220-226. The user is then presented with the show “Thirty Rock” and decides to watch “Thirty Rock.” The user may watch the show full screen or in a navigation window. While watching the show, the user may press the “Actions” button 244 to ask the set-top box 108 to perform certain actions for this show. In some embodiments, when the user presses the “Actions” button 244, an Actions menu appears and the image behind the menu will dim. In some embodiments, the user may then select to rate the program, make a one time recording of the program, record the program on an ongoing basis, or add the program to the user's personal play list. Again, any actions that the user selects to perform by using the scroll wheel 228 or otherwise will be tracked and used by the system 100 to fine-tune the presentation of personalized content for that user.

The various categories of personal interfaces such as “My Shows” may be presented in a variety of ways. In some embodiments, they may be divided into subcategories. These subcategories may be presented to the user in stacked form and in order of predicted preference to aid simple navigation. The user will then use the scroll wheel 228 to scroll to a certain category and press the select button 232 built into the scroll wheel 228 to select the category. Each category may be further subdivided into multiple selections and may also be presented to the user in stacked form.

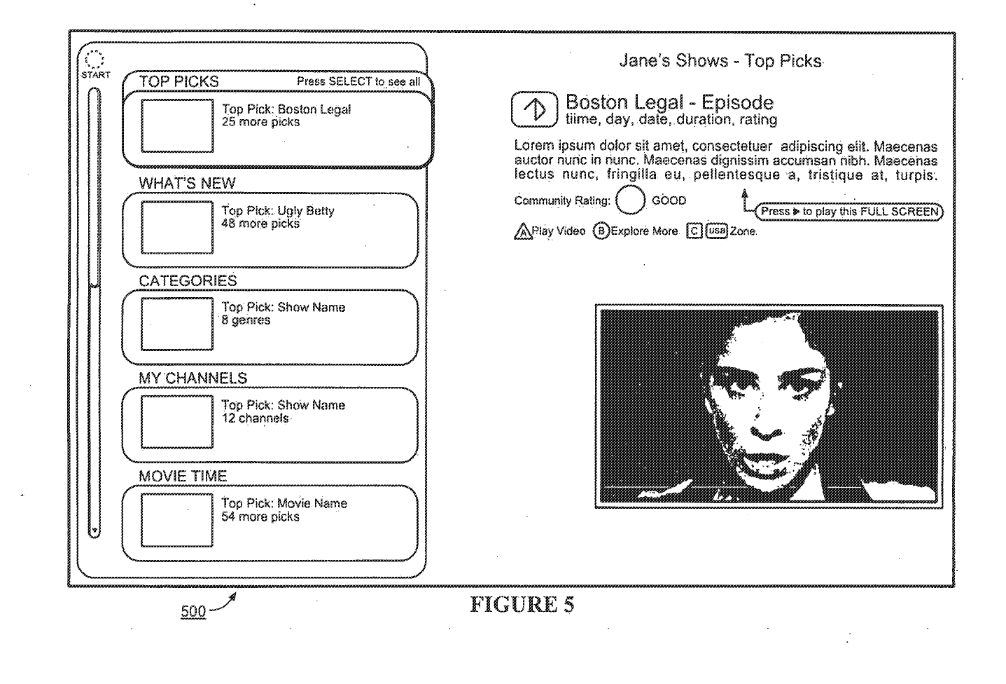

FIG. 5 is a schematic screenshot of a personal content presentation interface in accordance with some embodiments. The user can navigate to this user interface by using the scroll wheel 228 or by pressing the “My Shows” button 224 or a similar button corresponding to this particular user interface. The user interface displays a stack of subcategories to the left side of the screen. In the particular embodiment shown in FIG. 5, the subcategories includes “Top Picks,” “What's New,” “Categories,” “My Channels,” “My Movies,” and so forth. The category “Top Picks” includes all shows, movies, or other types of programs that are most relevant to the user. The interface also displays a video window to the right of the screen. This video window will either continue to play what the user was currently watching elsewhere before that user navigated to the “My Shows” interface or it will begin playing that user's “top pick.” In some embodiments, as the user scrolls down the stack of subcategories using the scroll wheel 228, the video window will display the currently highlighted selection from the stack. In addition, the user may press the “Actions” button 244 to display an Actions menu that allows the user to perform some preference related action on the particular content being displayed. In some embodiments, these preference related actions include “Rate Program or Series,” “Record Program or Series,” “Subscribe or Unsubscribe to series,” “Add to Play List,” “Save in Archive,” or any other similar types of preference related action commands. It should be appreciated that other user interfaces may be presented in a similar manner.

In addition to presenting shows, movies, and/or other programs tailored specifically for the user who pressed the dedicated user button 202-210, the system 100 may also present advertising targeted to that user. Presentation of advertising may take a variety of forms.

In some embodiments, for example, when the user logs into his/her account on the system 100 by pressing the dedicated user button 202-210 and begins watching shows presented to him/her, advertisements targeted to him/her may be inserted during a particular show. Or in the case where the user fast forwards, rewinds, or pauses through a presented show by pressing the corresponding buttons or other activation means on the remote control unit 102, advertisements targeted to that user may be inserted in the form of still image, dynamic image, or video overlays. Or, in various locations in the user interface, still image or video advertisements targeted to that user may be presented to the user as he/she navigates the user interface. In some embodiments, when the user logs into his/her account on the system 100, the advertising content is personalized to that user. For example, the advertisement may refer to the user by name or offer the user an ability to receive further information by email, phone, or other means divorced from the set top box 108.

In some embodiments, to ensure that advertisements will be available for inclusion in a user interface or programming content, segments of advertisements are delivered to the set-top boxes 108 over the video delivery network 110. In some embodiments, the intelligent video programming system 100 includes an intelligent advertising targeting system to accomplish the targeting of advertising to specific users.

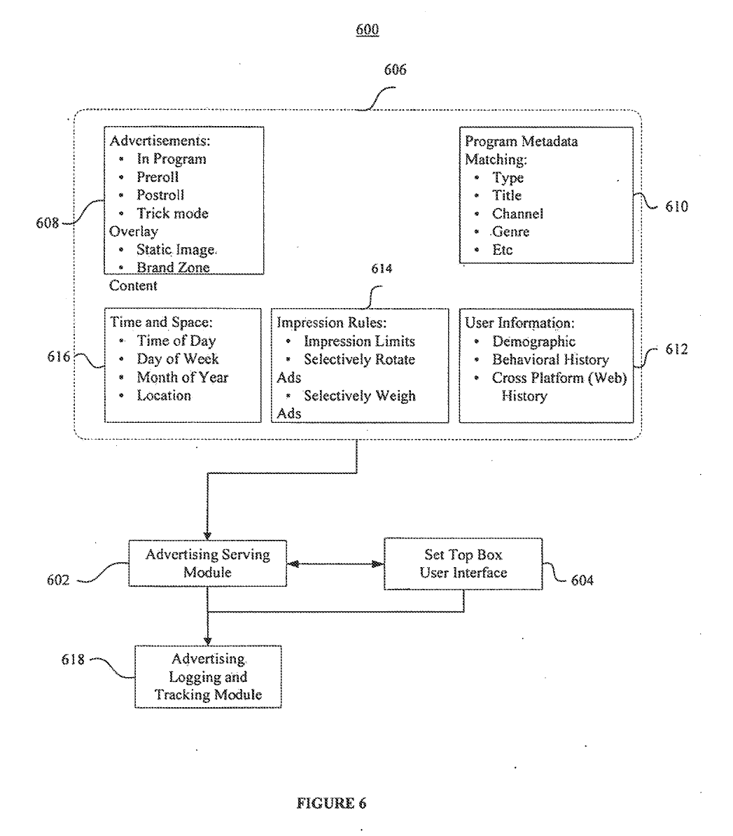

FIG. 6 is a block diagram illustrating an intelligent advertising targeting system in accordance with some embodiments. The system 600 includes an advertising serving module 602 that interacts with a user interface 604 to select advertisements to present to a specific user who pressed the user button 202-210 on remote control unit 102. The advertising serving module 602 makes such determinations according to which user is operating the remote control unit 102, cues from that user's interface on the set-top box 108, and rule sets 606 determined by various active advertising campaigns. In some embodiments, the advertising serving module 602 may be located within either the set-top box 108 or the remote control unit 102. In some other embodiments, the advertising serving module 602 may be located elsewhere in the system 100.

In some embodiments, when the user logs into his/her personal account on the system 100, the advertising serving module 602 is aware of information associated with that user 612 such as demographic information (e.g. age, gender, etc.) and behavioral history on the system 100. Furthermore, in some embodiments, the advertising serving module 602 may also be aware of the user's behavioral history on other systems and platforms. For example, the advertising serving module 602 may be aware of the user's World Wide Web/Internet viewing history on a personal computer. Such information may serve as an additional basis for advertisement targeting when the user logs into his/her account on the system 100. The advertising serving module 602 then serves advertisements according to the set of specific rules 606 that incorporate not only such user information 612, but also information regarding advertising type 608, program metadata 610, time and space 616, and impression rules 614.

In some embodiments, with respect to information regarding advertising type 608, a given campaign may include all or many advertising types. For example, a specific advertisement in the advertising campaign may be targeted specifically for pre-roll while a separate advertisement can be targeted specifically for post-roll. Information regarding program metadata 610 includes the ability to target advertising by specific metadata matching. This may include, for example, metadata matching by content type (e.g. movies versus episodic), by show title (e.g. “Seinfeld”) or by specific episode number (e.g. “Seinfeld Episode 23”), by category or genre (e.g. “Reality”), by channel (e.g. “Discovery”), or by any other type of program metadata matching. In some embodiments, information regarding time and space 616 includes targeted advertising based on time of day, week, or month and/or by geographic location. In some embodiments, impression rules 614 includes the ability to limit advertising impressions for specific advertisements and to further rotate or selectively weigh specific advertisements in the advertising campaign. According to some embodiments, depending on which user has logged into that user's account on the system 100, specific impression counts are then tracked and logged in an advertising tracking module 618 and fed back into an advertising campaign management system in a network operations center portion of the system 100. In some embodiments, the advertising tracking module 618 is located within the set-top box 108 or the remote control unit 102. In some other embodiments, however, the advertising tracking module 618 may be located elsewhere in the system 100.

Other forms of identity tie-ins may be presented when the user presses the dedicated user button 202-210. In some embodiments, the dedicated user button 202-210 may identify a user for purposes of parental control. In some other embodiments, the dedicated user button 202-210 may identify a user for purposes of logging into third-party services. For example, pressing the dedicated user button 202-210 may log that user into his/her Yahoo, YouTube, Google, or AOL accounts. In some other embodiments, the dedicated user button 202-210 may identify a user for purposes of community and social networking features such as community rating, video, tagging, play list sharing, or user-to-user instant messaging. For example, pressing a user's dedicated user button 202-210 may sign that user into his/her instant messaging account and allow him/her to chat with other users. In some other embodiments, pressing the user button 202-210 may also drive enablement and disablement of digital rights management for that particular user. In addition, pressing the user button dedicated to that user may also identify the user for purposes of account management and billing.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for displaying content, comprising:
at a receiver controller,
receiving user-identifying signals from a user-activated remote control device;
using the user-identifying signals to identify a specific user; and
causing personalized content specific to the identified user to be displayed.

2. The method of claim 1, wherein the causing personalized content specific to the identified user to be displayed includes
presenting the personalized content in a list on a display device; and
selecting the personalized content from the presented list using the user-activated remote control device.

3. The method of claim 2, wherein the list of personalized content is displayed as an overlay to at least a portion of content being displayed by the display device.

4. The method of claim 1, further comprising
tracking actions, including at least one content selection action made using the user-activated remote control device; and
using the tracked actions to select the personalized content specific to the identified user.

5. The method of claim 1 wherein the causing personalized content specific to the identified user to be displayed includes displaying targeted advertising specific to the identified user.

6. The method of claim 5, wherein the targeted advertising is inserted into the personalized content for presentation.

7. The method of claim 5, wherein the targeted advertising is displayed during content fast forward, rewind, and pause operations initiated using the user-activated remote control.

8. The method of claim 1, further comprising displaying information about at least one previously displayed content in response to a signal from the remote control device, the displayed information at least partially overlaying content being displayed by the display device.

9. The method of claim 1, wherein the personalized content is selected based, at least in part, on personal information of the identified user.

10. The method of claim 9, wherein the personal information was entered using the user-activated remote control device.

11. A method for displaying content, comprising:
at a receiver controller,
receiving user-identifying signals from a user-activated remote control device;
using the user-identifying signals to identify a specific user;
tracking viewing behavior of the identified user in response to viewing commands received from the user-activated remote control device;
selecting personalized content specific to the identified user based on the tracked behavior; and
causing the selected personalized content to be displayed.

12. A content display system, comprising:
a receiver controller configured to couple to a display device;
the receiver controller being configured to:
receive user-identifying signals for identifying a specific user,
identify the specific user in response to the user-identifying signals, and
cause presentation of personalized content specific to the identified user on the display device.

13. The system of claim 12, wherein the system is configured to present the personalized content in a list on the display device and to select programming content from the list using the user-activated remote control device.

14. The system of claim 13, wherein the system is configured to display the list of personalized content as an overlay to at least a portion of content being displayed by the display device in response to a signal from the user-activated remote control device.

15. The system of claim 12, wherein the system is configured to track programming content selected by an identified user and to use the tracked programming content selections to select the personalized content specific to the identified user.

16. The system of claim 12, wherein the system is configured to present targeted advertising specific to the identified user.

17. The system of claim 16, wherein the system is configured to insert the targeted advertising into the personalized content for presentation by the system.

18. The system of claim 12, wherein the system is configured to display information about at least one previously displayed content and the displayed information is partially overlaying content being displayed by the display device.

19. The system of claim 12, wherein the system is configured to select the personalized content based, at least in part, on personal information of the identified user.

20. The system of claim 19, wherein the personal information was entered using the user-activated remote control device.

21. A content display system, comprising:
a receiver controller configured to couple to a display device;
the receiver controller being configured to:
receive user-identifying signals for identifying a specific user,
identify the specific user in response to the user-identifying signals,
cause tracking of viewing behavior of the identified user,
select personalized content for the identified user based on the tracked viewing behavior, and
cause presentation of the selected personalized content for the identified user on the display device.

22. A method for displaying content, comprising
at a receiver controller,
receiving user-identifying signals from a user-activated remote control device; and
causing targeted advertising, specific to a user identified by the user-identifying signals, to be presented on a display device.

23. The method of claim 22, wherein the targeted advertising is inserted into personalized content specific to the identified user for presentation.

24. The method of claim 22, wherein the targeted advertising is displayed during content fast forward, rewind, and pause operations initiated by the user-activated remote control device.

25. The method of claim 22, further comprising:
selecting personalized content specific to the identified user;
presenting a list of selected personalized content on a display device; and
using the user-activated remote control device to select content from the presented list of the selected personalized content for viewing.

26. The method of claim 25, further comprising
tracking actions, including at least one content selection action made using the user-activated remote control device; and
using the tracked actions to select the personalized content specific to the identified user for display.

27. The method of claim 25, wherein the list of personalized content is displayed as an overlay to at least a portion of content being displayed by the display device.

28. The method of claim 25, further comprising displaying information about at least one previously displayed content in response to a signal from the user-activated remote control device, the displayed information at least partially overlaying content being displayed by the display device.

29. The method of claim 25, wherein the personalized content is selected based, at least in part, on personal information of the identified user.

30. The method of claim 29, wherein the personal information was entered using the user-activated remote control device.

31. A content displaying system, comprising:
a receiver controller configured to couple to a display device;
the receiver controller being configured to:
receive user-identifying signals for identifying a specific user,
cause presentation of targeted advertising specific to the identified user on the display device.

32. The system of claim 31, wherein the system is configured to insert targeted advertising into personalized content specific to the identified user for presentation.

33. The system of claim 31, wherein the system is configured to present targeted advertising during content fast forward, rewind, and pause operations initiated using the user-activated remote control device.

34. The system of claim 31, wherein the system is configured to select personalized content specific to the identified user, to present a list of the selected personalized content on the display device, and to respond to commands from the user-activated remote control device for choosing personalized content from the presented list for viewing.

35. The system of claim 34, wherein the system is configured to display the list of personalized content as an overlay to at least a portion of content being displayed by the display device in response to a signal from the user-activated remote control device.

36. The system of claim 34, wherein the system is configured to display information about at least one previously displayed content and the displayed information is partially overlaying content being displayed by the display device.

37. The system of claim 34, wherein the system is configured to select personalized content based, at least in part, on personal information of the identified user.

38. The system of claim 37, wherein the personal information was entered using the user-activated remote control device.

39. A remote control unit, comprising:
a housing; and
a plurality of buttons supported by the housing, including:
a user button being assignable to a specific user such that selection of the user button causes generation of user identification signals to identify the specific user, and
a group button, in communication with the control circuitry, to allow association with a group such that selection of the group personalizable button causes the remote control device to transmit a signal to cause display of content specific to the group.

40. The remote control unit of claim 39, wherein the user button is configured to cause the remote control to generate at least one signal to turn on the power for the video display device.

41. The remote control unit of claim 39, further comprising a scroll wheel on the body for causing signals to be generated to allow a user to navigate menus for selecting content for display by the video display device.

42. The remote control unit of claim 41, wherein the scroll wheel has disposed about its outer circumference a plurality of content display control keys for controlling subsequent display of content being displayed by the video device at a first display rate, the keys being selected from the group consisting of:
a skip forward key that, if selected, causes generation of signals that cause the displayed content to skip forward by a predetermined time interval.
a fast forward key that, if selected, causes generation of signals that cause the displayed content to be displayed at a rate faster than the first display rate;
a skip back key that, if selected, causes generation of signals that cause the displayed content to skip back by a predetermined time interval; and
a rewind key that, if selected, causes generation of signals that cause the displayed content to be displayed in reverse.

43. A remote control unit, comprising:
a plurality of keys configured to generate signals to communicate with a receiver controller, including:
a first key configured to cause transmission of user-identifying signals for identifying a specific user corresponding to the receiver controller, and
a second key configured to cause transmission of a group-identifying signal for identifying a specific group of users to the receiver controller and to cause programming content associated with the specific group of users to be displayed on a display device.

44. A remote control device, comprising:
circuitry configured to generate control signals for use in communicating user inputs to a video device;
a transmitter configured to transmit the control signals to cause the video device to display content;
a plurality of control keys each in communication with the control circuitry and respectively adapted to receive a selection of at least one of an associated function from the group of functions consisting of causing display of a home page, causing display of a personalized list of content sources, and causing display of a general list of content sources;
a plurality of user buttons, each in communication with the control circuitry to allow one-to-one association between a specific user and a specific one of the plurality of user buttons such that, once the association has been made, selection of a personalizable button causes the remote control device to transmit user identifying signals to cause display of content personalized for the associated user; and
a user-activated control pad configured for scroll through and selection of content displayed on the video device.

45. The remote control unit of claim 43, wherein the control pad includes a sensory pad configured to detect human touch movement to cause generation of signals for controlling image display on the video display device.

46. The remote control unit of claim 45, wherein the sensory pad is circular and has disposed about its outer circumference a plurality of content display control keys for controlling subsequent display of content being displayed by the video device at a first display rate, the keys being selected from the group consisting of:
a skip forward key that, if selected, causes generation of signals that cause the displayed content to skip forward by a predetermined time interval.
a fast forward key that, if selected, causes generation of signals that cause the displayed content to be displayed at a rate faster than the first display rate;
a skip back key that, if selected, causes generation of signals that cause the displayed content to skip back by a predetermined time interval; and
a rewind key that, if selected, causes generation of signals that cause the displayed content to be displayed in reverse.

47. The remote control unit of claim 45, wherein the user buttons include a group button, in communication with the control circuitry to allow association with a group such that selection of the group personalizable button causes the remote control device to transmit a signals to cause display of content specific to that specific group.

48. The remote control unit of claim 43, wherein the user buttons are configured to cause the remote control to generate at least one signal to turn on the power for the video display device.

49. A remote control device, comprising:
circuitry configured to generate control signals for use in communicating user inputs to a video device;
transmission means for transmitting the control signals to cause the video device to display content;
a plurality of control key means each in communication with the control circuitry and respectively for receiving a selection of at least one of an associated function from the group of functions consisting of causing display of a home page, causing display of a personalized list of content sources, and causing display of a general list of content sources;
a plurality of user button means, each in communication with the control circuitry and for allowing one-to-one association between a specific user and a specific one of the plurality of user buttons such that, once the association has been made, selection of a personalizable button causes the remote control device to transmit user identifying signals to cause display of content personalized for the associated user; and
a control means for allowing scroll through and selection of content displayed on the video device.
